(19) United States
(12) Patent Application Publication
(10) Pub. No.: US 2025/0052686 A1
(43) Pub. Date: Feb. 13, 2025

(54) METHOD AND APPARATUS FOR IMPROVING SENSITIVITY OF VACUUM TESTING OF VACUUM SWITCH

(71) Applicant: XI'AN JIAOTONG UNIVERSITY, Xi'an (CN)

(72) Inventors: Xiaohua WANG, Xi'an (CN); Jiaqi Liu, Xi'an Shaanzi (CN); Huan Yuan, Xi'an (CN); Aijun Yang, Xi'an (CN); Jifeng Chu, Xi'an (CN); Dingxin Liu, Xi'an (CN); Mingzhe Rong, Xi'an (CN)

(21) Appl. No.: 18/400,939

(22) Filed: Dec. 29, 2023

(30) Foreign Application Priority Data
Aug. 10, 2023 (CN) 2023110047412

(51) Int. Cl. G01N 21/71

(52) U.S. Cl. CPC G01N 21/718; G01N 2201/06113

(57) ABSTRACT

Disclosed is a method for improving sensitivity of vacuum testing of a vacuum switch, including the following steps: S100: smearing a water-soluble metal nanoparticle reagent evenly on a surface of a target material of a to-be-tested vacuum switch, performing standing and forming a metal nanoparticle coating on the surface of the target material; S200: bombarding, by using laser pulse, the surface of the target material where the metal nanoparticle coating is formed, so as to generate plasma on the surface of the target material; S300: obtaining a plasma image by collecting the plasma, and obtaining a plasma spectrum by performing spectroscopic analysis on the plasma image; and S400: obtaining a vacuum degree of the to-be-tested vacuum switch based on the plasma spectrum. The present disclosure can effectively improve a laser focusing degree and laser pulse stability and reduce noise interference, so as to lower testing limits and improve the sensitivity of online vacuum testing of the vacuum switch.

### CROSS-REFERENCE TO RELATED APPLICATION

This application claims priority from the Chinese patent application 2023110047412 filed Aug. 10, 2023, the content of which is incorporated herein in the entirety by reference.

### TECHNICAL FIELD

The disclosure herein relates the technical field of laser diagnosis, in particular to a method and apparatus for improving sensitivity of vacuum testing of a vacuum switch.

### BACKGROUND

Compared with air switches and oil switches, vacuum switches have the advantages of low failure rate, compact structure, strong breaking ability, simple maintenance and the like. They are widely used in power systems, coal mining, petrochemicals, and other fields. In actual use, as the service life increases, due to factors such as aging of mechanical components and insulation deterioration of the vacuum switches, an internal vacuum degree will gradually decrease, so it is necessary to test the vacuum degree of the vacuum switches. Vacuum degree measurement for the vacuum switches can be done in two ways: online and offline. An offline testing technology is relatively mature, while most online testing technologies are still in a research stage. Currently, relatively mature vacuum degree testing methods include: a shielding case color judgment method, an arc observation method, a spark counting method, an aspirant film method, an arc voltage/current method, a power frequency withstand voltage method, a magnetic control discharge method, an emission current attenuation method, a contact/immersion sensor method, and an X-ray method, but these methods require a piece of equipment to be out of operation. In view of the lack of effective online testing means for the vacuum degree of vacuum arc extinguishing chambers, and in order to effectively utilize resources, a technology that accurately tests the vacuum degree of a vacuum switch under operating conditions based on laser induced breakdown spectroscopy (LIBS) has been proposed in the market. This technology relies on theoretical analysis of a formation process of laser plasma. In a plasma expansion process, initial plasma formed by a target material will interact with ambient air, and molecules of the ambient air are excited and ionized and therefore participates in the formation process of the laser plasma. That is, a portable laser emitter is used to generate pulse laser so as to bombard a metal shield of a glass casing of the vacuum arc extinguishing chamber to generate plasma on the nanosecond timescale and sub-millimeter spatial scale on a surface of the shield. Then the technology measures a laser-induced plasma signal (including Cu, N, H, O atomic radiation spectra) to reflect the vacuum degree. In real-time testing, noise interference encountered by the laser-induced plasma signal during the induction of the target material by LIBS will affect the result of generation of a spectrum signal, making the sensitivity low and the testing limits high. In some fields with higher requirements for precision, the technology cannot complete a testing work well, so there is an urgent need to improve the sensitivity of LIBS to solve the problem of sensitivity deficiency.

There are already many technologies that can improve the sensitivity of LIBS, such as a dual-pulse LIBS technology, which increases ablation rate and atmospheric effects on the sample surface, and absorbs a second beam of laser pulse in the expanding plasma to reheat the plasma generated by a first beam of laser pulse. Another example is the use of annular magnets to enhance detection sensitivity. The enhancement effect of annular magnets is attributable to the simultaneous existence of spatial and magnetic confinement, which can increase plasma temperature and electron density. Some other technologies involve external electric or magnetic fields. However, these technologies are implemented through external energy sources or tunable lasers and are not suitable for the closed environment of an arc extinguishing chamber of the vacuum switch.

### SUMMARY

In view of shortcomings in the prior art, the present disclosure aims to provide a method for improving sensitivity of vacuum testing of a vacuum switch. The method can effectively improve a laser focusing degree and laser pulse stability and reduce noise interference, so as to lower testing limits and improve the sensitivity of online vacuum testing of the vacuum switch.

To achieve the above objectives, the present disclosure provides the following technical solution:
a method for improving sensitivity of vacuum testing of a vacuum switch, including the following steps:
S100: smearing a water-soluble metal nanoparticle reagent evenly on a surface of a target material of a to-be-tested vacuum switch, performing standing and forming a metal nanoparticle coating on the surface of the target material;
S200: bombarding, by using laser pulse, the surface of the target material where the metal nanoparticle coating is formed, so as to generate plasma on the surface of the target material;
S300: obtaining a plasma image by collecting the plasma, and obtaining a plasma spectrum by performing spectroscopic analysis on the plasma image; and
S400: obtaining a vacuum degree of the to-be-tested vacuum switch based on the plasma spectrum.

Preferably, the water-soluble metal nanoparticle reagent includes a water-soluble silver nanocolloid reagent or a water-soluble gold nanocolloid reagent.

Preferably, a concentration of the metal nanoparticle reagent is 0.01 mg/ml to 0.1 mg/ml.

Preferably, a radius of metal nanoparticles in the metal nanoparticle reagent is 10 nm.

The present disclosure further provides an apparatus for improving sensitivity of vacuum testing of a vacuum switch, including:
a laser emission module, configured to emit laser to irradiate a target material where a metal nanoparticle coating is formed in a to-be-tested vacuum switch so as to generate plasma on a surface of the target material;
a collecting module, configured to collect the plasma to obtain a plasma image;
an analyzing module, configured to perform spectroscopic analysis on the plasma image to obtain a plasma spectrum; and
a testing module, configured to test the plasma spectrum to obtain a vacuum degree of the to-be-tested vacuum switch.

Preferably, the laser emission module includes a laser emitter. A focusing lens and a dichroscope are arranged on a light path of the laser emitter.

Preferably, the collecting module includes an ICCD camera.

Preferably, the analyzing module includes a spectrometer.

Preferably, the testing module includes an upper computer.

Preferably, the collecting module further includes a digital delay pulse generator.

Compared with the prior art, the present disclosure has the beneficial effects that:

1. By smearing the metal nanoparticle reagent on the target material in the vacuum switch to form the coating, the laser-induced plasma image and a spectrum signal can have a higher signal-to-noise ratio and an enhanced effect and can be high in repeatability. The situation that a spectral line of the signal is submerged in noise or cannot be told from the noise is avoided. The problems of low sensitivity, high testing limits and large noise interference in traditional LIBS laser pulse are solved.

The metal nanoparticle colloid reagent is used as the coating, a measuring process is simple, safe and reliable, and a more precise testing effect can be achieved. In some fields with higher requirements for precision, testing work cannot be well completed by a laser-induced spectrum bombarding technology, and at this time, it is necessary to use NELIBS to improve signal intensity, usually by 1 or 2 order of magnitudes.

### BRIEF DESCRIPTION OF FIGURES

FIG. 1 is a flow chart of a method for improving sensitivity of vacuum testing of a vacuum switch provided by another embodiment of the present disclosure.

FIG. 2A is a spectrum signal diagram obtained by a 0.1 mg/ml reagent concentration and by not smearing any reagent.

FIG. 2B is a spectrum signal diagram obtained by a 0.05 mg/ml reagent concentration and by not smearing any reagent.

FIG. 2C is a spectrum signal diagram obtained by a 0.01 mg/ml reagent concentration and by not smearing any reagent.

FIG. 3 is a schematic structural diagram of an apparatus for improving sensitivity of vacuum testing of a vacuum switch provided by an embodiment of the present disclosure.

### DESCRIPTION OF REFERENCE NUMERALS IS AS FOLLOWS

1. Laser emitter; 2. Focusing lens; 3. Dichroscope; 4. Vacuum arc extinguish chamber; 5. Spectrometer; 6. ICCD camera; and 7. Delay pulse generator.

### DETAILED DESCRIPTION

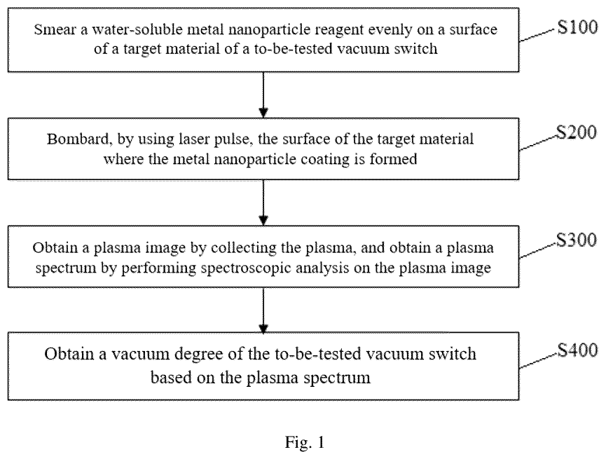

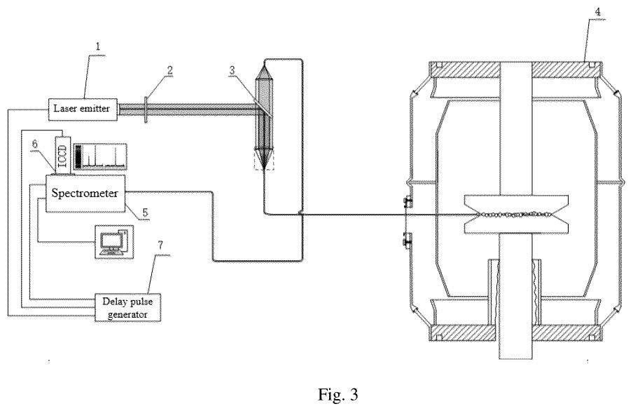

Specific embodiments of the present disclosure will be described in detail with reference to FIG. 1 to FIG. 3. Although specific embodiments of the present disclosure are illustrated in accompanying drawings, it should be understood that the present disclosure may be implemented in various forms and should not be limited by the embodiments set forth herein. On the contrary, these embodiments are provided to have a more thorough understanding of the present disclosure and to fully convey the scope of the present disclosure to those skilled in the art.

It should be noted that certain terms are used in the specification and claims to refer to specific components. Those skilled in the art should understand that those skilled may use different terms to refer to the same component. The specification and the claims do not use the difference in nouns as a way to distinguish components, but the difference in function of components as a criterion for distinguishing. For example, references to “including” or “comprising” throughout the specification and claims are an open-ended term and should be construed as “including, but not limited to”. The specification is subsequently described as the preferred embodiments of the present disclosure, but it is intended for the general principles of the specification and not intended to limit the scope of the present disclosure. The scope of protection of the present disclosure shall be defined by the attached claims.

To facilitate understanding of the embodiments of the present disclosure, further explanation and description will be made below with specific embodiments as examples in combination with the accompanying drawings. The drawings shall not constitute limitation to any embodiment of the present disclosure.

In one embodiment, as shown in FIG. 1, the present disclosure provides a method for improving sensitivity of vacuum testing of a vacuum switch, including the following steps:
S100: a pure copper sheet is taken as an experimental target material of a to-be-tested vacuum switch, a silver nanoparticle reagent with a concentration of 0.01 mg/ml and a particle radius of 10 nm is dropped on the target material, the reagent is then smeared by a glass rod into an even rectangle and is subjected to standing and dried, and a silver nanoparticle coating is formed on a surface of the target material;
S200: the surface of the target material where the silver nanoparticle coating is formed is bombarded by using laser pulse, so as to generate plasma on the surface of the target material;
S300: the plasma is collected to obtain a plasma image, and spectroscopic analysis is performed on the plasma image to obtain a plasma spectrum; and
S400: a vacuum degree of the to-be-tested vacuum switch is obtained based on the plasma spectrum.

In another embodiment, the present disclosure further provides a method for improving sensitivity of vacuum testing of a vacuum switch. Specifically, a concentration of a silver nanoparticle reagent in this embodiment is 0.05 mg/ml. For comparison of concentration, reference may be made to following description.

In yet another embodiment, the present disclosure further provides a method for improving sensitivity of vacuum testing of a vacuum switch. This embodiment is different in that a concentration of a silver nanoparticle reagent is 1 mg/ml.

In yet another embodiment, the present disclosure further provides a method for improving sensitivity of vacuum testing of a vacuum switch. This embodiment is different in that the silver nanoparticle reagent is replaced with a gold nanoparticle reagent, and a concentration of the gold nanoparticle reagent is also set to be 0.01 mg/ml to 1 mg/ml.

The above embodiments constitute a complete technical solution of the present disclosure. In the solution illustrated by the embodiments, because gold nanoparticles or silver nanoparticles are evenly distributed on the surface of the target material, on the one hand, the surface of the target material is rougher, and a breakdown threshold of laser pulse can be lowered; and on the other hand, a mutual effect between the laser pulse and the target material is mainly achieved through the gold nanoparticles or the silver nanoparticles, laser is first in contact with and coupled to the nanoparticles when bombarding the target material. Under an action of a laser electromagnetic field, electron coherence oscillation in the nanoparticles generates dipoles and excites an electromagnetic field, so that a localized surface plasmon (LSP) can be formed on the surface of the target material, and the LSPs of adjacent nanoparticles will be coupled to each other and generate a stronger electromagnetic field in a particle gap, thus forming a “hot spot”. A strong electric field of the “hot spot” is the reason for field electron emission. In addition, because the localized surface plasmons of adjacent nanoparticles are coupled to each other, the electromagnetic fields between adjacent nanoparticles overlap each other, a stronger oscillation electromagnetic field is generated in a gap between the nanoparticles. Under an action of the oscillation electromagnetic field, an ionization generating mechanism is switched from multiphoton ionization to field electron emission. Electron emission is completed in a moment under an action of a strong electric field, and before the nanoparticles fully melt, ionization is caused and the plasma is generated. In this way, self-emission of the plasma is imaged on an end face of a collecting light path and be transmitted to an ICCD camera through a transmission light path. Therefore, a signal-to-noise ratio of a plasma signal is enhanced, and testing limits are effectively improved.

In one specific embodiment, the present disclosure conducts a laser bombarding experiment respectively on target materials coated with the gold nanoparticle reagent or silver nanoparticle reagent of different concentrations and target materials not coated with the gold nanoparticle reagent or silver nanoparticle reagent, so as to illustrate the technical effects of the present disclosure.

The experiment uses a Q-switch Nd: YAG laser emitter with a wavelength of 1064 nm and uses a signal generator to generate a pulse signal so as to control the laser emitter to emit laser pulse. In the experiment, the target material that is the copper sheet is placed in a vacuum cavity with a quartz window, laser focusing is realized by using a convex lens with a focal length of 150 nm so energy is concentrated at a bombarding point of the target material, laser and the plasma generated through induction is isolated by the dichroscope, and a spectrum signal of the plasma is analyzed by the spectrometer and the ICCD camera. In a low air pressure test, a mechanic pump is used to exhaust the vacuum cavity, a thermion combination vacuum gauge is used to test air pressure in the cavity in real time, and the copper sheet in the vacuum cavity is moved by using a three-dimensional stepping motor.

At the beginning of the experiment, the vacuum cavity is sealed first, then a first-stage pump is used for exhausting. When a vacuum degree in the vacuum cavity reaches 10⁻³ Pa, a signal generator is used to generate a pulse signal to trigger the laser emitter and induce the generation of the plasma which is collected passing a light path system to obtain the corresponding spectrum. Because a duration between emission of the laser from the laser emitter and action on the copper sheet is short, an impact of such duration on delay time may be neglected. After receiving a light signal, the spectrometer transmits it to a computer and uses AVANTES software to display a waveform of the spectrum. The plasma image captured by the ICCD camera is analyzed by Andor software and Matlab software to obtain corresponding intensity data.

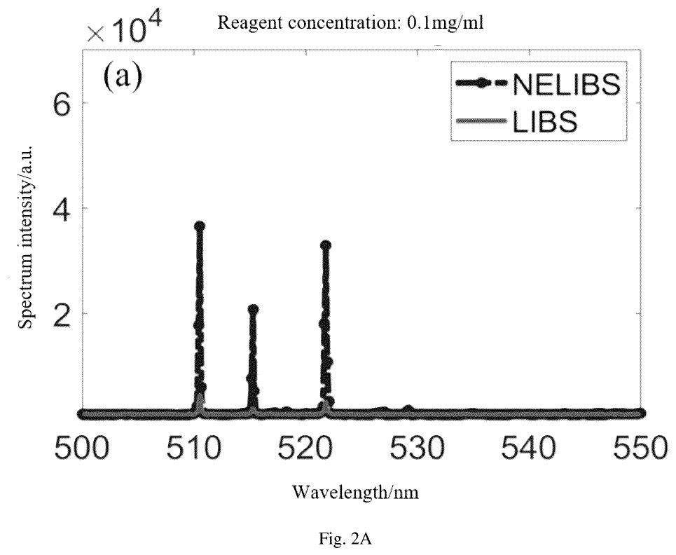

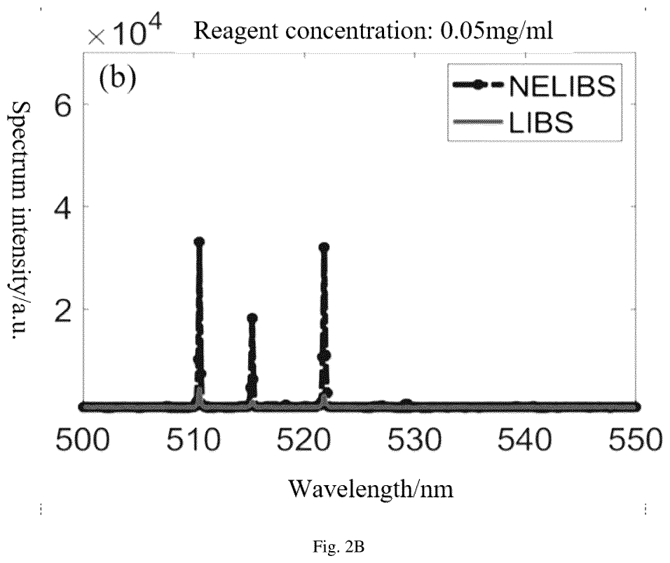

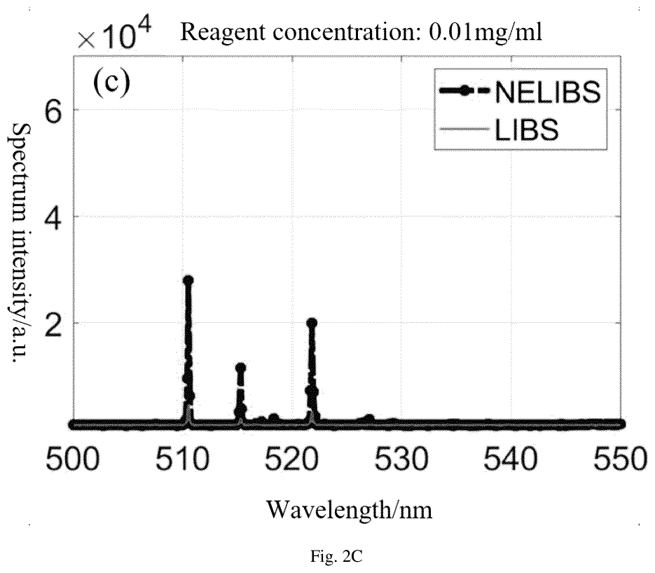

Through the above experiment, for the silver nanoparticle reagent, spectrum signal diagrams of the plasma shown in FIG. 2(a) to FIG. 2(c) may be obtained. FIG. 2(a) is a spectrum signal diagram obtained by a 0.1 mg/ml reagent concentration and by not smearing any reagent; FIG. 2(b) is a spectrum signal diagram obtained by a 0.05 mg/ml reagent concentration and by not smearing any reagent; and FIG. 2(c) is a spectrum signal diagram obtained by a 0.01 mg/ml reagent concentration and by not smearing any reagent. In FIG. 2(a) to FIG. 2(c), spectrum signal intensities of the plasma coated with the reagent are much larger than spectrum signal intensities of the plasma not coated with any reagent. In FIG. 2(a), the spectrum signal intensity of the plasma at 510.5 nm is 36000a.u.; in FIG. 2(b), the spectrum signal intensity of the plasma at 510.5 nm is 33000a.u.; and in FIG. 2(c), the spectrum signal intensity of the plasma at 510.5 nm is 28000a.u. It can be seen that when the concentration of nanoparticles decreases, the plasma signal intensity also slightly decreases. Through experimental verification, a concentration of 0.1 mg/ml is the optimal concentration for the silver nanoparticle reagent, because the plasma spectral signal intensity is the highest at this concentration. In addition, through experimental verification, concentrations of silver nanoparticle reagents ranging from 0.01 mg/ml to 0.1 mg/ml and concentrations of gold nanoparticle reagents ranging from 0.01 mg/ml to 0.1 mg/ml all meet the practical requirements. In the present disclosure, an effect of the metal nanoparticle coating is to improve the sensitivity of testing without causing interference to the plasma spectrum. Therefore, by adopting the relevant prior art that obtains the vacuum degree of the vacuum switch based on the plasma spectrum, the present disclosure can obtain the vacuum degree testing results of the vacuum switch at higher detection sensitivity.

In another embodiment, the present disclosure further provides an apparatus for improving sensitivity of vacuum testing of a vacuum switch, including:
a laser emission module, configured to emit laser to irradiate a target material where a metal nanoparticle coating is formed in a vacuum arc extinguish chamber 4 so as to generate plasma on a surface of the target material;
a collecting module, configured to collect the plasma to obtain a plasma image;
an analyzing module, configured to perform spectroscopic analysis on the plasma image to obtain a plasma spectrum; and
a testing module, configured to test the plasma spectrum to obtain a vacuum degree of the to-be-tested vacuum switch.

The above embodiments constitute a complete technical solution of the present disclosure. In this embodiment, by smearing the metal nanoparticle reagent on the target material in the vacuum switch to form the coating, the laser-induced plasma image and a spectrum signal can have a higher signal-to-noise ratio and an enhanced effect and can be high in repeatability. Therefore, testing limits of traditional LIBS laser pulse can be lowered, and the sensitivity of online vacuum degree testing of the vacuum switch can be improved.

In another embodiment, the laser emission module includes a laser emitter 1. A focusing lens 2 and a dichroscope 3 are arranged on a light path of the laser emitter 1.

In this embodiment, laser emitted by the laser emitter is focused by the focusing lens and reflected by the dichroscope to a transmission light path, and further irradiates along the transmission light path onto the target material coated with the metal nanoparticles in the to-be-tested vacuum switch, thus generating the plasma through induction.

In another embodiment, the collecting module includes an ICCD camera 6.

In another embodiment, the analyzing module includes a spectrometer 5.

In another embodiment, the testing module includes an upper computer.

In another embodiment, the collecting module further includes a digital delay pulse generator 7.

The applicant of the present disclosure has provided a detailed description of the embodiments in conjunction with the accompanying drawings. However, those skilled in the art should understand that the above embodiments are merely preferred examples of the present disclosure and are not limited to the specific embodiments mentioned above. The comprehensive description is provided to aid readers in better understanding the essence of the present disclosure, rather than limiting the scope of protection of the present disclosure. On the contrary, any improvements or modifications made based on the inventive spirit of the present disclosure should be included within the scope of protection of the present disclosure.

What is claimed is:

1. A method for improving sensitivity of vacuum testing of a vacuum switch, comprising the following steps:
S100: smearing a water-soluble metal nanoparticle reagent evenly on a surface of a target material of a to-be-tested vacuum switch, performing standing and forming a metal nanoparticle coating on the surface of the target material;
S200: bombarding, by using laser pulse, the surface of the target material where the metal nanoparticle coating is formed, so as to generate plasma on the surface of the target material;
S300: obtaining a plasma image by collecting the plasma, and obtaining a plasma spectrum by performing spectroscopic analysis on the plasma image; and
S400: obtaining a vacuum degree of the to-be-tested vacuum switch based on the plasma spectrum.

2. The method according to claim 1, wherein preferably, the water-soluble metal nanoparticle reagent comprises any one of the following: a water-soluble silver nanocolloid reagent or a water-soluble gold nanocolloid reagent.

3. The method according to claim 1, wherein a concentration of the metal nanoparticle reagent is 0.01 mg/ml to 0.1 mg/ml.

4. The method according to claim 1, wherein a radius of metal nanoparticles in the metal nanoparticle reagent is 10 nm.

5. An apparatus for improving sensitivity of vacuum testing of a vacuum switch, comprising:
a laser emission module, configured to emit laser to irradiate a target material where a metal nanoparticle coating is formed in a to-be-tested vacuum switch so as to generate plasma on a surface of the target material;
a collecting module, configured to collect the plasma to obtain a plasma image;
an analyzing module, configured to perform spectroscopic analysis on the plasma image to obtain a plasma spectrum; and
a testing module, configured to test the plasma spectrum to obtain a vacuum degree of the to-be-tested vacuum switch.

6. The apparatus according to claim 5, wherein the laser emission module comprises a laser emitter, wherein a focusing lens and a dichroscope are arranged on a light path of the laser emitter.

7. The apparatus according to claim 5, wherein the collecting module comprises an ICCD camera.

8. The apparatus according to claim 5, wherein the analyzing module comprises a spectrometer.

9. The apparatus according to claim 5, wherein the testing module comprises an upper computer.

10. The apparatus according to claim 5, wherein the collecting module further comprises a digital delay pulse generator.
